(19) United States
(12) Patent Application Publication
(10) Pub. No.: US 2003/0230278 A1
(43) Pub. Date: Dec. 18, 2003

(54) Engine pressure regulator

(76) Inventors: Kuo Chang Lin, Taichung City (TW); Chau Hwe Chen, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/171,991

(22) Filed: Jun. 17, 2002

(51) Int. Cl. F02B 75/02

(52) U.S. Cl. 123/316; 123/198 R

(57) ABSTRACT

An engine pressure regulator, used in an engine that can collect hydrogen and oxygen. The engine pressure regulator comprises: a body chamber; a connecting tube, through one side of the chamber; a passage mechanism, mounted inside the chamber having a passage connected to the inner space of the chamber; a needle tube mechanism, connected to one end of the connecting tube, and connected to the passage when compressed. The connecting tube is connected to the tube between the engine and the fuel pressure regulator. When the pressure of the engine is to high, the connecting tube will push the needle tube mechanism and the needle mechanism will connect to the passage and the over pressure gas from the engine will be released to the inner space of the chamber and therefore reduce the pressure. When the pressure of the engine is too low, the inside pressure will cause the gas inside the chamber flow to the engine to compensate the pressure.

### TECHNICAL FIELD

This invention relates generally to an engine pressure regulator, in particular, an engine pressure regulator used in the engine that can collect hydrogen and oxygen.

### BACKGROUND OF THE INVENTION

In general, with fuels used in internal combustion engines, external combustion engines, and other combustion apparatus, exhaust gases are generated by combustion to release various types of noxious chemical substances into the atmosphere, thus causing an environmental pollution. These noxious chemical substances include, for example, CO, HC, NOx, and SOx. Heretofore, to suppress generation of such noxious chemical substances, fuel combustion efficiency has been improved by improving the quality of fuels used or by improving various combustion devices. In addition, the exhaust gases released have been treated by a variety of exhaust gas removing devices using catalysts to prevent pollution. However, such prior art methods have been insufficient to reduce pollutive substances, and the improvement of fuel quality has been difficult in view of the costs. To overcome the defects, recently, the industry intends to use fuel activation devices to enhance combustion and reduce harmful gases. In the U.S. Pat. Nos. 4,605,498, 4,711,271, 5,055,189, 5,044,346, 5,080,080, 5,460,144, 5,632,254 and 5,873,353, magnetic field effect or far infrared ray is used to activate fuel to decompose the fuel molecule and therefore enhance combustion and reduce the harmful gases.

Combustion includes fuel, hydrogen in the fuel and oxygen in the air. Activating fuel only improves one element of combustion. Fuels like gasoline are composed mainly of carbon-hydrogen chemical compound with different molecule structures. The main elements of the compounds are carbon and hydrogen. The fuels, which contain high percentage of hydrogen usually, are easily ignited to produce power. Carbon and hydrogen are active elements. They can easily combine with oxygen and then blaze. Therefore if we can provide sufficient air (oxygen is about 20% of air), the combustion of the fuels will be efficient and less harmful gas will be produced. Adding more hydrogen and into combustion equipments like engines can reduce the consumption of fuels and adding oxygen can help the hydrogen both in the fuel and in the air burn and avoid the combine of carbon and hydrogen since usually carbon and hydrogen will combine as harmful gases.

However, in the engine system that can collect hydrogen and oxygen and reused them as described above may face a problem. The problem is that when the oxygen and hydrogen are supplied too much or not sufficient, the pressure inside the engine may become abnormal and cause some problem.

### SUMMARY OF INVENTION

It is therefore a primary objective of the present invention to provide an engine pressure regulator that can adjust the pressure of an engine efficiently.

The present invention, briefly summarized, in one embodiment discloses an engine pressure regulator, used in an engine that can collect hydrogen and oxygen, the regulator comprises: a body chamber; a connecting tube, through one side of the chamber; a passage mechanism, mounted inside the chamber having a passage connected to the inner space of the chamber; a needle tube mechanism, connected to one end of the connecting tube, and connected to the passage when compressed.

The connecting tube is connected to the tube between the engine and the fuel pressure regulator. When the pressure of the engine is too high, the connecting tube will push the needle tube mechanism and the needle mechanism will connect to the passage and the over pressured gas in the engine will be released to the inner space of the chamber and therefore reduce the pressure. When the pressure of the engine is too low, the inside pressure will cause the gas inside the chamber pass through the needle tube mechanism and the connecting tube to the engine to compensate the pressure.

### BRIEF DESCRIPTION OF DRAWINGS

The invention will be more clearly understood after refer to the following detailed description read in conjunction with the drawings wherein:

FIG. 1 is a functional diagram of the embodiment used in a engine system that can collect oxygen and hydrogen;

FIG. 2 is a functional diagram of the embodiment installed with a engine; and

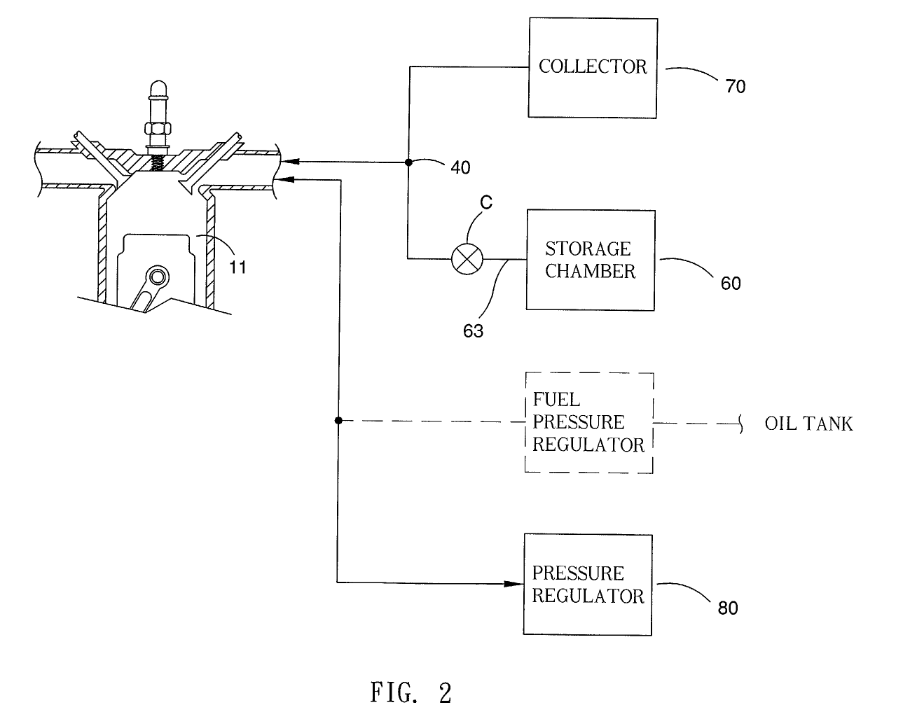

FIG. 3 is a sectional view of the embodiment.

### DETAILED DESCRIPTION OF PREFERRED EMBODIMENTS

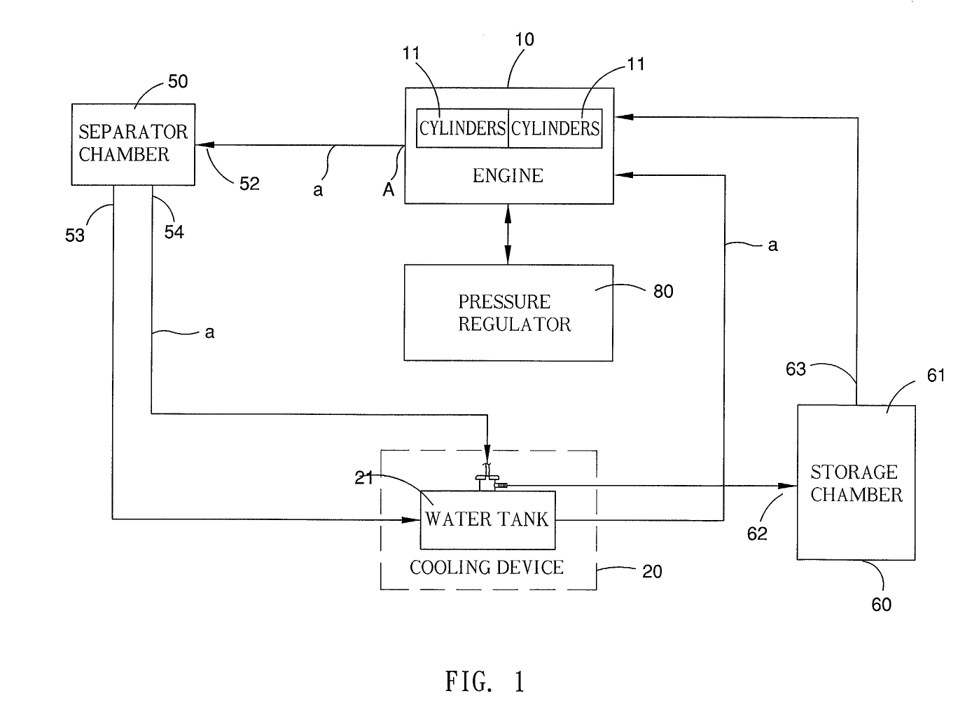

With reference to FIG. 1, the embodiment is used in an engine system that can collect hydrogen and oxygen. The system has an engine 10 with several cylinders 11 and an cooling device 20 connected to the engine 10, the cooling device 20 has at least one water tank 21 for outputting cooling water to the engine 10 and inputting heated cooling water from the engine 10. Part of the heated water is decomposed into oxygen and hydrogen because of high temperature. The separator chamber 50 is for separating liquid and gas, which comprises: an input 52 connected to the engine 10 for receiving heated cooling water; a first output 53, connected to the water tank 21, for outputting the heated cooling water to the water tank 21; and a second output 54, connected to the water tank 21, for outputting the oxygen and hydrogen to the water tank 21. The oxygen and hydrogen will follow the route of the cooling water (indexed as “a” in FIG. 1) flow into the separator chamber 50. Since gas is lighter and the flowing speed is faster, so hydrogen and oxygen can flow into the water tank 21 earlier. The temperature inside the water tank 21 is high enough to produce more hydrogen and oxygen.

The storage chamber 60 with sufficient space 61 has an input 62 connected to the water tank 21 for receiving oxygen and hydrogen inside the tank 21 and an output 63 connected to the engine 10 for outputting the oxygen and hydrogen to the cylinders 11.

However, it is possible that when providing of the oxygen and hydrogen is too much, it will cause the pressure inside the engine too high in an instant. To solve this problem, we can install a pressure regulator 80 connected to the tube between the engine 10 and fuel pressure regulator to release over pressured gas.

In the traditional engine driving system, generally speaking, a fuel pressure regulator is installed to adjust the pressure in the fuel tube. The fuel pressure regulator will have a tube connected to oil tank to collect surplus oil. However the pressure regulator 80 doesn't have tube connected to oil tank since there will be no surplus oil through the efficient combustion of the present invention.

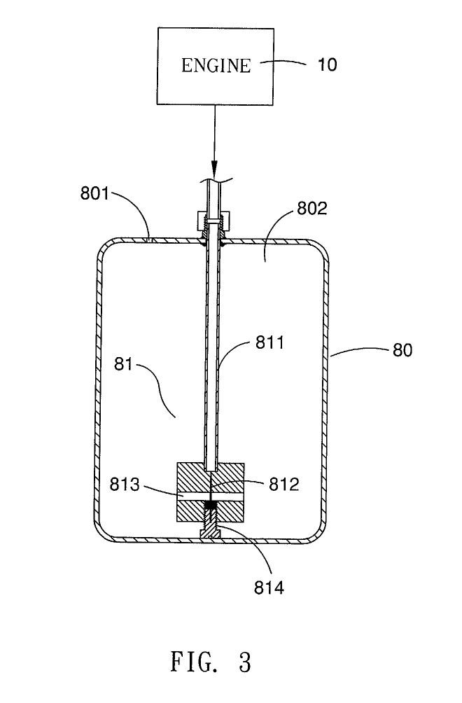

With reference to FIG. 3, the engine pressure regulator 80 comprises: a body chamber 801; a connecting tube 811, through one side of the chamber 801; a passage mechanism, mounted inside the chamber 801 having a passage 813 connected to the inner space of the chamber 801; a needle tube mechanism 812, connected to one end of the connecting tube 811, and connected to the passage 813 when compressed.

The connecting tube 811 is connected to the tube between the engine and the fuel pressure regulator. When the pressure of the engine 10 is to high, the connecting tube 811 will push the needle tube mechanism 812 and the needle mechanism 812 will connect to the passage 813 and the over pressure gas from the engine will be released to the inner space 81 of the chamber 801 through the needle tube mechanism 812 and connecting tube 811 and therefore reduce the pressure. When the pressure of the engine 10 is too low, the inside pressure will cause the gas inside the chamber 801 pass through the needle tube mechanism 812 and the connecting tube 811 to the engine 10 to compensate the pressure.

Since every engine has different critical pressure to decide when the pressure is too high, the embodiment 80 can further comprises a control valve 814 connected to the needle tube mechanism 812 for controlling the flow of the needle tube mechanism.

Numerous characteristics and advantages of the invention have been set forth in the foregoing description, together with details of the structure and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extend indicated by the broad general meaning of the terms in which the appended claims are expressed.

We claim:

1. An engine pressure regulator, used in an engine that can collect hydrogen and oxygen, said regulator comprises:
a body chamber;
a connecting tube, through one side of said chamber;
a passage mechanism, mounted inside said chamber having a passage connected to the inner space of said chamber;
a needle tube mechanism, connected to one end of said connecting tube, and connected to said passage when compressed.

2. The regulator of claim 1, further comprises a control valve connected to said needle tube mechanism for controlling the flow of said needle tube mechanism.
